(19) United States
(12) Patent Application Publication
(10) Pub. No.: US 2018/0236837 A1
(43) Pub. Date: Aug. 23, 2018

(54) Suspension Strut Bearing

(71) Applicant: Schaeffler Technologies AG & Co. KG, Herzogenaurach (DE)

(72) Inventors: Rainer Lutz, Markt Erlbach (DE); Andreas Wöllner, Nürnberg (DE); Arno Wolf, Höchstadt (DE); Gerhard Meyer, Lehrberg (DE)

(73) Assignee: Schaeffler Technologies AG & Co. KG, Herzogenaurach (DE)

(21) Appl. No.: 15/754,775

(22) PCT Filed: Jul. 25, 2016
(86) PCT No.: PCT/DE2016/200341

§ 371 Date: Feb. 23, 2018

(30) Foreign Application Priority Data
Sep. 10, 2015 (DE) 102015217289.9

(51) Int. Cl. B60G 15/06

(52) U.S. Cl. CPC B60G 15/068; B60G 2204/124; B60G 2204/128; B60G 2204/418; B60G 2206/82; B60G 2206/72; B60G 2206/7104; B60G 2206/81012; B60G 2204/45021

(57) ABSTRACT

A suspension strut bearing having a cap and a guide ring mounted such that it is rotatable in relation to the cap about an axis of rotation, a plain bearing or rolling bearing provided between the cap and the guide ring and a supporting ring provided for a bump stop, which supporting ring extends radially internally around the guide ring, and the supporting ring is connected to the guide ring with material fit.

### FIELD OF THE INVENTION

The invention relates to a suspension strut bearing which is provided for use in suspension struts.

### BACKGROUND OF THE INVENTION

Suspension strut bearings are part of the wheel suspension in independent wheel suspensions. The wheel suspension enhances the desired driving safety and driving comfort as well as the light and precise steering of the wheels. The wheel suspension is intended to keep road noises away from the body and to be as light as possible. Depending on the design, the suspension strut bearing guides the shock spring and forms a supporting surface for the shock absorber end stop. The suspension strut bearing absorbs the radial and axial forces transmitted via the shock spring and to the shock absorber and ensures that the shock spring twists with little friction and without stress during steering and deflection and therefore operates without a restoring torque.

Suspension strut bearings are often part of so-called McPherson suspension struts. As such, the suspension strut here comprises a telescopic shock absorber having a piston rod, which is movably guided in a cylinder, and a shock spring which surrounds the shock absorber and serves as a vehicle suspension spring. The suspension strut bearing is provided with a cap, which is fastened to the chassis-side suspension strut dome, and with a guide ring on which the shock spring is supported and by which the shock spring is guided. The guide ring is mounted such that it is rotatable in relation to the cap. The bearing enables the spring to rotate with respect to the vehicle body during steering since the entire suspension strut rotates during steering movements.

DE 10 2010 011 423 A1 discloses a suspension strut bearing which has a cap and a guide ring which is rotatable in relation to the cap. A bearing is arranged between the cap and the guide ring. A supporting ring for a bump stop is furthermore provided, which supporting ring extends radially internally around the guide ring. The guide ring has at its radially inner holding elements engage in a receiving means of the supporting ring in order to connect these to one another with form fit.

DE 10 2008 005 031 A1 describes a suspension strut bearing having a cap and a guide ring. A bearing is arranged between the cap and the guide ring. A supporting ring is furthermore provided for a bump stop, which supporting ring extends radially internally around the guide ring. The supporting ring is counter-mounted in a self-supporting manner on the guide ring.

### SUMMARY OF THE INVENTION

The object of the present invention is to provide a suspension strut bearing which can be manufactured economically and can be assembled as easily as possible.

According to the invention, the object is achieved by a suspension strut bearing having a cap and a guide ring which is mounted such that it is rotatable in relation to the cap about an axis of rotation, wherein a plain bearing or rolling bearing is provided between the cap and the guide ring and a supporting ring is provided for a bump stop, which supporting ring extends radially internally around the guide ring, wherein the supporting ring is connected to the guide ring with material fit.

Suspension strut bearings have a cap and a guide ring which is connected to the cap in a captive manner, for example by means of a snap connection. A bearing is provided between the cap and the guide ring. This bearing is formed as a plain bearing. The cap is fastened to a dome bearing of a chassis of a motor vehicle. The guide ring receives an axial end of a shock spring on an outer circumference. Spring forces of the shock spring are conducted via the guide ring into the cap and, from there, into the dome bearing. A supporting ring extending radially internally around the guide ring is provided to support a bump stop. The bump stop serves to form a resilient end stop for the suspension strut in the event of a strong deflection, wherein a cylinder of the shock absorber strikes against the bump stop. The bump stop is manufactured from a suitable elastomer for this purpose.

In the suspension strut bearing according to the invention, the supporting ring for the bump stop is connected to the guide ring with material fit. The seat of the supporting ring is thus unable to become loose or displaced in the guide ring in spite of the high stresses and varying thermal expansion of the components.

According to one embodiment of the invention, the guide ring is injection molded to the supporting ring. To this end, the supporting ring is inserted into the injection molding tool of the guide ring. The guide ring is then injection molded. The supporting ring is thus injection molded into or to the guide ring or the guide ring is injection molded to the supporting ring. This is advantageous in that it is possible to connect the guide ring to the supporting ring at the same time as the guide ring is produced and the assembly is thereby simplified on the one hand. On the other hand, positioning errors which arise during the assembly of the guide ring and the supporting ring can be prevented.

The guide ring or the supporting ring preferably has protruding elements which fix the bump stop in place. The protruding elements can be formed for example as lugs, a raised portion or as toothed portions or the like. These protruding elements can engage in a corresponding counter-piece on the bump stop, or simply abut against it, for example to form an abutment. By fixing the bump stop in place, it is possible to prevent positioning errors of the bump stop in relation to the supporting ring or the guide ring over a long period of use. Such positioning errors can contribute to reducing the useful life of the suspension strut bearing.

In a further embodiment of the invention, the supporting ring is formed from a steel material. This is particularly advantageous since the load absorption of the forces acting via the bump stop are introduced into the supporting ring. However the invention is not restricted to the supporting ring being manufactured from a steel material. It goes without saying that, in an appropriate design, it is also possible to produce the supporting ring from another suitable metal material or stable plastics material.

According to one embodiment of the invention, the guide ring is formed from a plastics material. Since the load absorption via the bump stop and the load absorption via the shock spring are separate, it is advantageous to form the guide ring in this way. Alternatively, the guide ring can be produced from a die casting or a metal.

### BRIEF DESCRIPTION OF THE DRAWINGS

An exemplary embodiment of the invention is described below with reference to two figures, which show:

FIG. 1 a partial longitudinal section through an inventive suspension strut bearing according to a first embodiment; and

FIG. 2 a partial longitudinal section through an inventive suspension strut bearing according to a second embodiment.

### DETAILED DESCRIPTION OF THE DRAWINGS

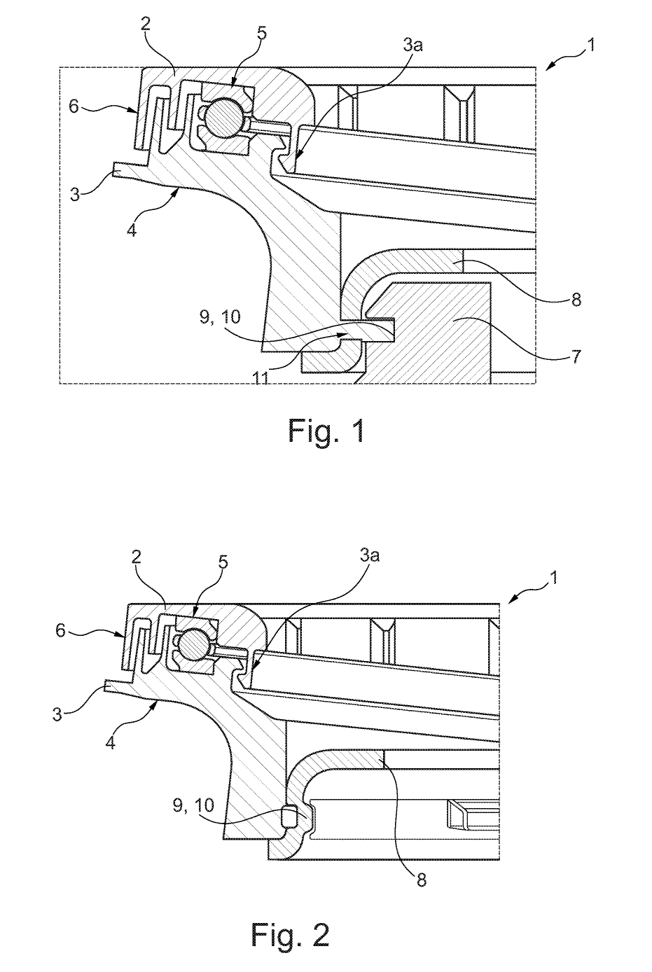

FIG. 1 shows a partial longitudinal section through an inventive suspension strut bearing 1 according to a first embodiment. The suspension strut bearing 1 has a cap 2 and a guide ring 3 which is mounted such that it is rotatable in relation to the cap 2 about an axis of rotation D. The cap 2 is connected to the guide ring 3 by means of a snap connection 3a. The cap 2 is fastened to a dome bearing (not illustrated) of a chassis of a motor vehicle. The guide ring 3 receives an axial end of a shock spring (not illustrated) on an outer surface 4.

Via a plain bearing 5, the guide ring 3 is mounted on the cap 2 axially in the direction of the axis of rotation D. The plain bearing 5 serves to transmit forces acting along the axis of rotation D from the guide ring 3 to the cap 2. A seal 6 is furthermore provided between the cap 2 and the guide ring 3. In this exemplary embodiment, the seal 6 is designed as a labyrinth seal. However, a contact seal is also possible.

A bump stop 7 made from a suitable elastomer is furthermore arranged centrally about the axis of rotation D, which bump stop serves as an end stop for the shock absorber (not illustrated) of the suspension strut. In the event of a strong deflection of the suspension strut here, the cylinder of the shock absorber strikes against the bump stop 7 from below. The piston rod (not illustrated) of the shock absorber extends approximately along the axis of rotation D shown.

For the load absorption via the bump stop 7, a supporting ring 8 is provided in the guide ring 3, which supporting ring extends radially internally around the guide ring 3. The supporting ring 8 is connected to the guide ring 3 with material fit. To this end, the guide ring 3 is injection molded onto the supporting ring 8 during its production, thereby enabling a fixed and permanent connection.

To fix the bump stop 7 in place, the guide ring 3 has protruding elements 9 which are formed as lugs 10. These lugs 10 reach through openings 11 in the supporting ring 8 and engage in corresponding counter-pieces on the bump stop 7.

FIG. 2 shows a partial longitudinal section through an inventive suspension strut bearing 1 according to a second embodiment. To simplify the description, the reference signs used are the same as in the previous FIG. 1. The description is restricted merely to the features which differ from FIG. 1.

In contrast to FIG. 1, the supporting ring 8 has a protruding element 9 which serves to fix a bump stop (not illustrated in more detail) in place. The protruding element 9 is formed as a raised portion 12.

### LIST OF REFERENCE SIGNS

D Axis of rotation

1 Suspension strut bearing

2 Cap

3 Guide ring

3a Snap connection

4 Outer surface

5 Rolling bearing

6 Seal

7 Bump stop

8 Supporting ring

9 Protruding element

10 Lugs

11 Opening

1. A suspension strut bearing comprising:
a cap and a guide ring which is mounted such that it is rotatable in relation to the cap about an axis of rotation;
a bearing provided between the cap and the guide ring; a supporting ring provided for a bump stop, the supporting ring extends radially internally around the guide ring; and
the supporting ring is connected to the guide ring with material fit.

2. The suspension strut bearing of claim 1, wherein the guide ring is injection molded to the supporting ring.

3. The suspension strut bearing of claim 1, wherein the guide ring or the supporting ring has protrusions which fix the bump stop in place.

4. The suspension strut bearing of claim 1, wherein the supporting ring is formed from a steel material.

5. The suspension strut bearing of claim 1, wherein the guide ring is formed from a thermoplastic material.

6. A strut bearing comprising:
a cap;
a guide ring rotatably mounted to the cap;
a bearing disposed between the cap and the guide ring; and
a supporting ring fixedly connected to the guide ring.

7. The strut bearing of claim 1, wherein the guide ring is integrally formed with the supporting ring.

8. The strut bearing of claim 2, wherein the guide ring is injection molded to the supporting ring.

9. The strut bearing of claim 1, further comprising a bump stop operatively contacting the supporting sring.

10. The strut bearing of claim 9, wherein at least one of the guide ring and the supporting ring include protrusions extending into the bump stop.

11. The strut bearing of claim 10, wherein the protrusions fix the bump stop in position.
